(19) United States
(12) Patent Application Publication
(10) Pub. No.: US 2014/0108903 A1
(43) Pub. Date: Apr. 17, 2014

(54) METHODS AND SYSTEMS FOR CORPORATE PERFORMANCE MANAGEMENT

(71) Applicant: Host Analytics, Inc., Redwood City, CA (US)

(72) Inventors: Steve Tak-Shu TAI, Menlo Park, CA (US); Bryan Alan DEHMLER-BUCKLEY, Denver, CO (US)

(73) Assignee: HOST ANALYTICS, INC., Redwood City, CA (US)

(21) Appl. No.: 13/758,730

(22) Filed: Feb. 4, 2013

Related U.S. Application Data
(60) Provisional application No. 61/713,301, filed on Oct. 12, 2012.

(51) Int. Cl. G06F 17/24

(52) U.S. Cl. CPC G06F 17/246
USPC 715/212

(57) ABSTRACT

A computing module and method for corporate performance management (CPM) is disclosed. A spreadsheet is determined for inclusion in a CPM software application. Dimensional members associated with the spreadsheet are captured, and hierarchies associated with the spreadsheet based on the captured dimensional members and formulas in the spreadsheet are determined. A spreadsheet template associated with the spreadsheet is determined and data from the spreadsheet is obtained. The spreadsheet template, dimensional members, hierarchies, and data are then published into the CPM software application.

### CROSS-REFERENCE

This application claims the benefit of U.S. Provisional Application No. 61/713,301, filed Oct. 12, 2012, which application is incorporated herein by reference.

### BACKGROUND OF THE INVENTION

Companies typically invest large amounts of time, personnel, and money to manage their business. Often, one or more financial people manage the business using a spreadsheet, such as Microsoft Excel®. Spreadsheet templates (e.g., Excel® templates) are typically used to manage the business, such as templates for budgeting and/or forecasting the performance of the company.

At some later time (e.g., as the company grows), companies typically realize that the spreadsheet cannot efficiently meet their expanding business needs. When this occurs, companies often purchase and implement a Corporate Performance Management (CPM) solution (such as the CPM Suite developed by Host Analytics, Inc. of Redwood City, Calif.) which allows the company to design, model, analyze and report on their financial and operational performance. The process to design and implement a solution in a CPM software application coming from Excel® or another spreadsheet can be a time consuming and expensive one. See, for example, U.S. Patent Publication US 2010/0293450 A1 published Nov. 18, 2010, for System and Method for Simulating Discrete Financial Forecast Calculations, by Ratkowski et al.

### SUMMARY OF THE INVENTION

If companies were able to leverage the investment which they have made in spreadsheet (e.g., Excel®) templates to programmatically create similar or related objects in a CPM software application, they would be able to save money (e.g., less time spent for consultants or internal resource hours spent) and time (e.g., speedier implementation timeframes if objects are automatically created).

In one aspect of the disclosure, a method and a computing module executing on a computing device include determining a spreadsheet for inclusion in a Corporate Performance Management (CPM) software application, capturing dimensional members associated with the spreadsheet, determining hierarchies associated with the spreadsheet based on the captured dimensional members and formulas in the spreadsheet, capturing a spreadsheet template associated with the spreadsheet, obtaining data from the spreadsheet, and publishing the spreadsheet template, dimensional members, hierarchies, and data into the CPM software application.

In another aspect of the disclosure, the determining of the spreadsheet further comprises receiving, by the computing device, the spreadsheet from a user. The capturing of the dimensional members can further include receiving a selection of a range of cells in the spreadsheet. If the range of cells is in multiple columns, a hierarchy is determined based on repeat spreadsheet formulas in a column. If the range of cells is in a single column, a hierarchy is determined based on repeat spreadsheet formulas in a row. Additionally, a user can edit one or more of the dimensional members and/or hierarchies.

In still another aspect of the disclosure, the capturing of the spreadsheet template includes receiving a selection of the spreadsheet template. The capturing can include receiving a selection of a range of cells in the spreadsheet. The receiving of the selection can include capturing a data range based on an intersection of row ranges and column ranges. Further, data, formula, and format in the data range can also be captured.

### INCORPORATION BY REFERENCE

All publications, patents, and patent applications mentioned in this specification are herein incorporated by reference to the same extent as if each individual publication, patent, or patent application was specifically and individually indicated to be incorporated by reference.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings of which:

FIG. 1 is a block diagram of a client device communicating over a network with a server computer in accordance with the present disclosure;

FIG. 2A is a flowchart illustrating steps performed by a CPM module in accordance with the present disclosure;

FIG. 2B is a block diagram of the CPM module in accordance with the present disclosure;

FIG. 3 is a flowchart illustrating steps performed to capture dimensional members and hierarchy of a spreadsheet in accordance with the present disclosure;

FIG. 4 is a screen shot of a spreadsheet template showing the capturing of dimensional members and hierarchy in accordance with the present disclosure;

FIG. 5 is a screen shot of another spreadsheet template showing the capturing of dimensional members and hierarchy in accordance with the present disclosure;

FIG. 6 is a flowchart illustrating steps performed to capture a spreadsheet template in accordance with the present disclosure;

FIG. 7 is a screen shot of a spreadsheet template to illustrate the capturing of the template in accordance with the present disclosure;

FIG. 8 is a screen shot of a spreadsheet template for capturing by the CPM module in accordance with the present disclosure;

FIG. 9 is a screen shot of a capturing process of the template by the CPM module in accordance with the present disclosure;

FIG. 10 is a screen shot of a listing of dimensional members with respect to a template in accordance with the present disclosure;

FIG. 11 is a screen shot of a template design created by the CPM module for a CPM software application in accordance with the present disclosure;

FIG. 12 is a screen shot of data that will be loaded into the CPM software application in accordance with the present disclosure;

FIG. 13 is a screen shot of a user selecting to publish the captured information to the CPM software application in accordance with the present disclosure;

FIG. 14 is a block diagram of components of a client device in accordance with the present disclosure; and

FIG. 15 is a block diagram illustrating an internal architecture of a computer in accordance with the present disclosure.

### DETAILED DESCRIPTION OF THE INVENTION

Various embodiments and configurations are disclosed herein; however, it is to be understood that the disclosed embodiments and configurations are merely illustrative of the disclosure that can be embodied in various forms. In addition, each of the examples given in connection with the various embodiments is intended to be illustrative, and not restrictive. Further, the figures are not necessarily to scale, some features may be exaggerated to show details of particular components (and any size, material and similar details shown in the figures are intended to be illustrative and not restrictive). Therefore, specific structural and functional details disclosed herein are not to be interpreted as limiting, but merely as a representative basis for teaching one skilled in the art to variously employ the disclosed embodiments.

The present disclosure is described below with reference to block diagrams and operational illustrations of methods and devices to select and present media related to a specific topic. It is understood that each block of the block diagrams or operational illustrations, and combinations of blocks in the block diagrams or operational illustrations, can be implemented by means of analog or digital hardware and computer program instructions. These computer program instructions can be provided to a processor of a general purpose computer, special purpose computer, application specific integrated circuit (ASIC), or other programmable data processing apparatus, such that the instructions, which execute via the processor of the computer or other programmable data processing apparatus, implements the functions/acts specified in the block diagrams or operational block or blocks.

In some alternate implementations, the functions/acts noted in the blocks can occur out of the order noted in the operational illustrations. For example, two blocks shown in succession can in fact be executed substantially concurrently or the blocks can sometimes be executed in the reverse order, depending upon the functionality/acts involved. Furthermore, the embodiments of methods presented and described as flowcharts in this disclosure are provided by way of example in order to provide a more complete understanding of the technology. The disclosed methods are not limited to the operations and logical flow presented herein. Alternative embodiments are contemplated in which the order of the various operations is altered and in which sub-operations described as being part of a larger operation are performed independently.

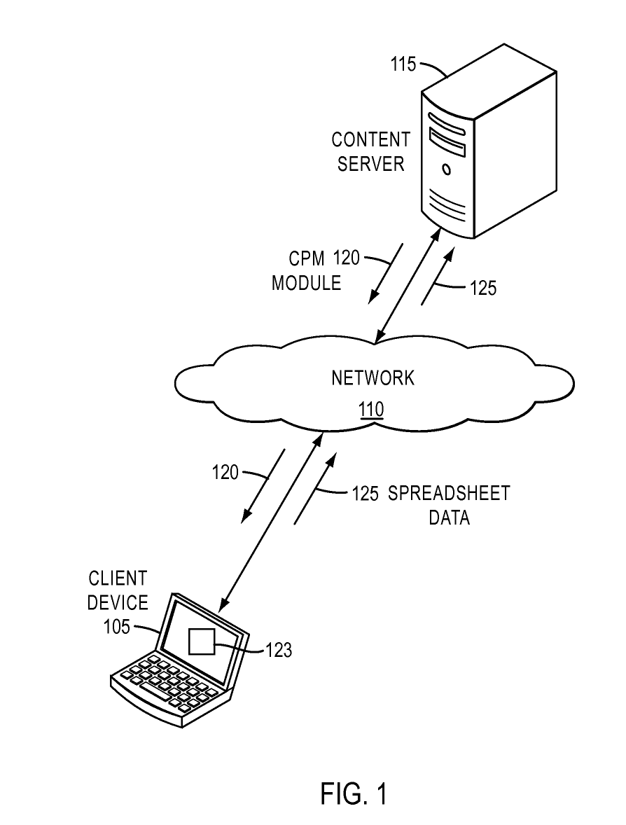

FIG. 1 is a schematic diagram illustrating an example of a network and devices implementing the present disclosure. As will be appreciated by those skilled in the art, networks and devices implementing the disclosure may vary, for example, in terms of arrangement or in terms of type of components. Such alternative configurations are within the scope of the disclosure. FIG. 1 includes, for example, a client device 105 in communication over a network 110. The network 110 may be a local area network (LAN)/wide area network (WAN), such as the Internet, so that the client device 105 can communicate with a content server 115 (also referred to below as server computer 115 or server 115). Network 110 may be any type of network, such as a wireless network or a wired network.

A computing device may be capable of sending or receiving signals, such as via a wired or wireless network, or may be capable of processing or storing signals, such as in memory as physical memory states, and may, therefore, operate as a server. Thus, devices capable of operating as a server may include, as examples, dedicated rack-mounted servers, desktop computers, laptop computers, set top boxes, integrated devices combining various features, such as two or more features of the foregoing devices, or the like. Servers may vary widely in configuration or capabilities, but generally a server may include one or more central processing units and memory. A server may also include one or more mass storage devices, one or more power supplies, one or more wired or wireless network interfaces, one or more input/output interfaces, or one or more operating systems, such as Windows Server, Mac OS X, Unix, Linux, FreeBSD, or the like.

Content server 115 may include a device that includes a configuration to provide content via a network to another device. A content server 115 may, for example, host a web site, such as a business site, educational site, dictionary site, encyclopedia site, wiki, financial site, government site, etc. Content server 115 may further provide a variety of services that include, but are not limited to, web services, third-party services, audio services, video services, email services, instant messaging (IM) services, short messaging system (SMS) services, multi-media messaging system (MMS) services, file transfer protocol (FTP) services, voice over IP (VOIP) services, calendaring services, photo services, or the like. Examples of content may include text, images, audio, video, or the like, which may be processed in the form of physical signals, such as electrical signals, for example, or may be stored in memory, as physical states, for example. Examples of devices that may operate as a content server include desktop computers, multiprocessor systems, microprocessor-type or programmable consumer electronics, etc.

A network is configurable such that it may couple devices so that communications may be exchanged, such as between a server and a client device or other types of devices, including between wireless devices coupled via a wireless network, for example. A network may also include mass storage, such as network attached storage (NAS), a storage area network (SAN), or other forms of computer or machine readable media, for example. Additionally, a network may include the Internet, one or more local area networks (LANs), one or more wide area networks (WANs), wire-line type connections, wireless type connections, or any combination thereof. Likewise, sub-networks, such as may employ differing architectures or may be compliant or compatible with differing protocols, may interoperate within a larger network. Various types of devices may, for example, be made available to provide an interoperable capability for differing architectures or protocols. As one illustrative example, a router may provide a link between otherwise separate and independent LANs.

A communication link or channel may include, for example, analog telephone lines, such as a twisted wire pair, a coaxial cable, full or fractional digital lines including T1, T2, T3, or T4 type lines, Integrated Services Digital Networks (ISDNs), Digital Subscriber Lines (DSLs), wireless links including satellite links, or other communication links or channels, such as may be known to those skilled in the art. Furthermore, a computing device or other related electronic devices may be remotely coupled to a network, such as via a telephone line or link, for example.

A wireless network may couple client devices with a network. A wireless network may employ stand-alone ad-hoc networks, mesh networks, Wireless LAN (WLAN) networks, cellular networks, or the like. A wireless network may further include a system of terminals, gateways, routers, or the like coupled by wireless radio links, or the like, which may move freely, randomly or organize themselves arbitrarily, such that network topology may change, at times even rapidly. A wireless network may further employ a plurality of network access technologies, including Long Term Evolution (LTE), WLAN, Wireless Router (WR) mesh, or 2nd, 3rd, or 4th generation (2G, 3G, or 4G) cellular technology, or the like. Network access technologies may enable wide area coverage for devices, such as client devices with varying degrees of mobility, for example.

For example, a network may enable RF or wireless type communication via one or more network access technologies, such as Global System for Mobile communication (GSM), Universal Mobile Telecommunications System (UMTS), General Packet Radio Services (GPRS), Enhanced Data GSM Environment (EDGE), 3GPP Long Term Evolution (LTE), LTE Advanced, Wideband Code Division Multiple Access (WCDMA), Bluetooth, 802.11b/g/n, or the like. A wireless network may be configurable to include virtually any type of wireless communication mechanism by which signals may be communicated between devices, such as a client device or a computing device, between or within a network, or the like.

The server 115 is configurable such that it provides a corporate performance management (CPM) module 120 to the client device 105. The CPM module 120 is further configurable such that it exists in the “cloud” and is not downloaded to the client device 105. Thus, the client device 105 can access the CPM module 120 via, for example, a web page provided by the content server 115 and displayed on web browser 123. The CPM module 120 is also configurable such that it automatically obtains previously created spreadsheet data 125 and converts the spreadsheet data 125 to CPM data for use in a CPM software application (which may be accessible to the user via a web page) provided by the content server 115 or by a third party.

The spreadsheet data 125 can include any data or information associated with a spreadsheet, such as templates, dimensional members and their hierarchies, and/or the actual data that has been input into the spreadsheet (e.g., Microsoft® Excel® or Google® Spreadsheets®). A spreadsheet template is a standardized spreadsheet containing master information (e.g., layout, style information, data, formulas, report formats, etc.) for use in spreadsheet documents. A dimensional member is a title of a column in a spreadsheet. For example, if a column in a spreadsheet includes amounts of employee salaries, and the title of the column is “Employee Salary”, the dimensional member can be “Employee Salary”. A hierarchy thus can be the relationship between two or more dimensional members. For example, if each data field in the Employee Salary is dependent on a data field in a column titled “Employee Sales”, then the Employee Salary dimensional member is related to (e.g., a child of) the Employee Sales dimensional member. In another example, an original member is “North America” and then its children are U.S., Canada, and Mexico. In another example, “General Expenses” may be an original member with children of “Rent”, “Telephone”, and “Utilities”.

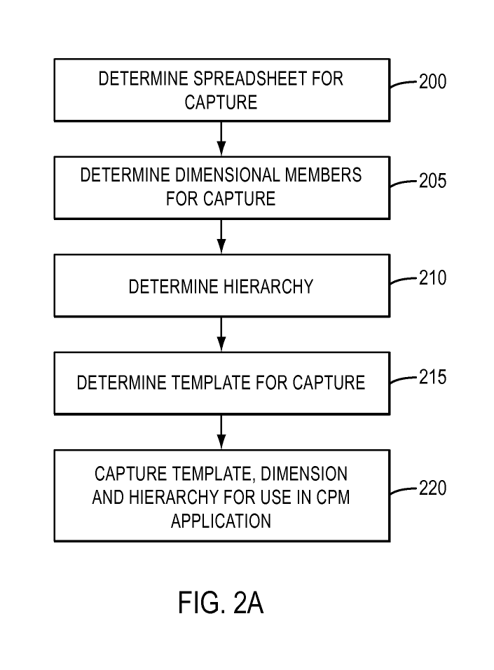

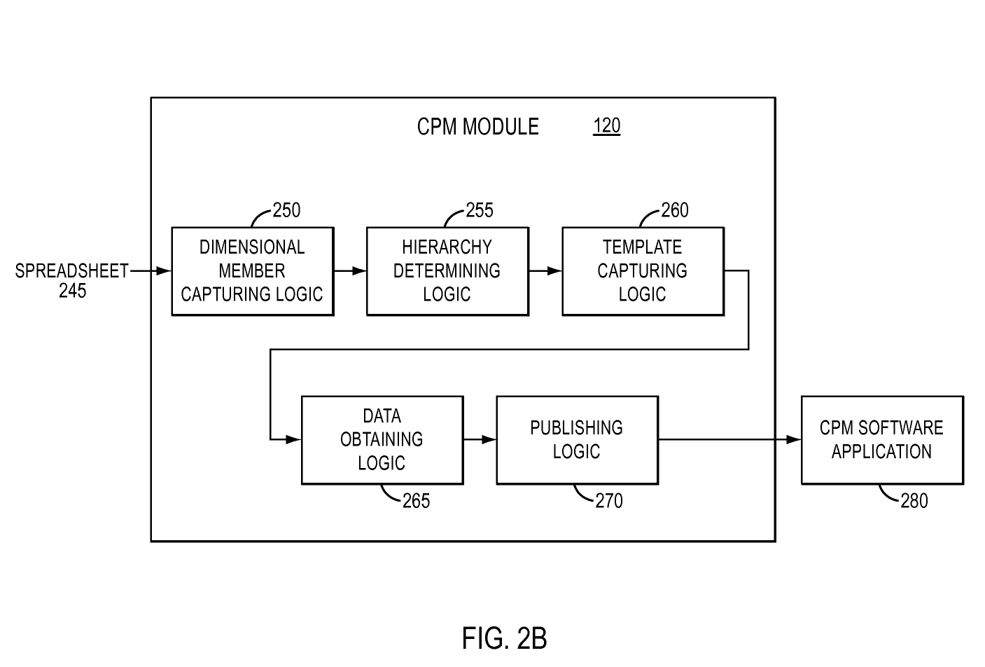

FIG. 2A is a flowchart illustrating an example of steps performable by the CPM module 120. FIG. 2B is a block diagram of an example of a suitable CPM module 120. As stated above, the CPM module 120 can be configurable to determine a spreadsheet 245 for capture (Step 200). For example, the user of the client device 105 can indicate the spreadsheet 245 to capture.

The CPM module 120 can then use dimensional member capturing logic 250 to determine dimensional members to capture (Step 205). In some configurations, the user of the client device 105 indicates the dimensional member(s) to capture.

The CPM module 120 can then use hierarchy determining logic 255 to determine hierarchy (Step 210) between dimensional members. This may be determined by analysis of the underlying formula (s) used to calculate the value(s) of one or more data fields in the spreadsheet 245. The CPM module 120 can then be configured to use template capturing logic 260 to determine one or more templates (e.g., input template) to capture (Step 215). In some configurations, the user of the client device 105 can indicate the template to capture when accessing the CPM module 120.

In other aspects, the CPM module 120 is configurable to use data obtaining logic 265 to capture the data from the spreadsheet 245. The CPM module 120 can then be configured to capture (using logic 250, 255, and 260) the template, dimension member(s) and/or hierarchy for use in a CPM software application 280 (Step 220). Additionally, the CPM module 120 can be configured to use publishing logic 270 to publish one or more of the template, dimension member(s), hierarchy, and/or data in one or more software programs. The data can also be published as a report in the application (e.g., CPM software application 280, Microsoft® Word®, Powerpoint®, Access®, etc.). The CPM module 120 can also be configured to enable a user of the client device 105 to change the way that the user can either create CPM applications or create CPM artifacts, such as templates, reports, metadata, and/or data values. Although the steps and logic shown in FIGS. 2A-B appear in a specific order, the steps and/or logic can occur in any feasible manner and order, as will be appreciated by those skilled in the art.

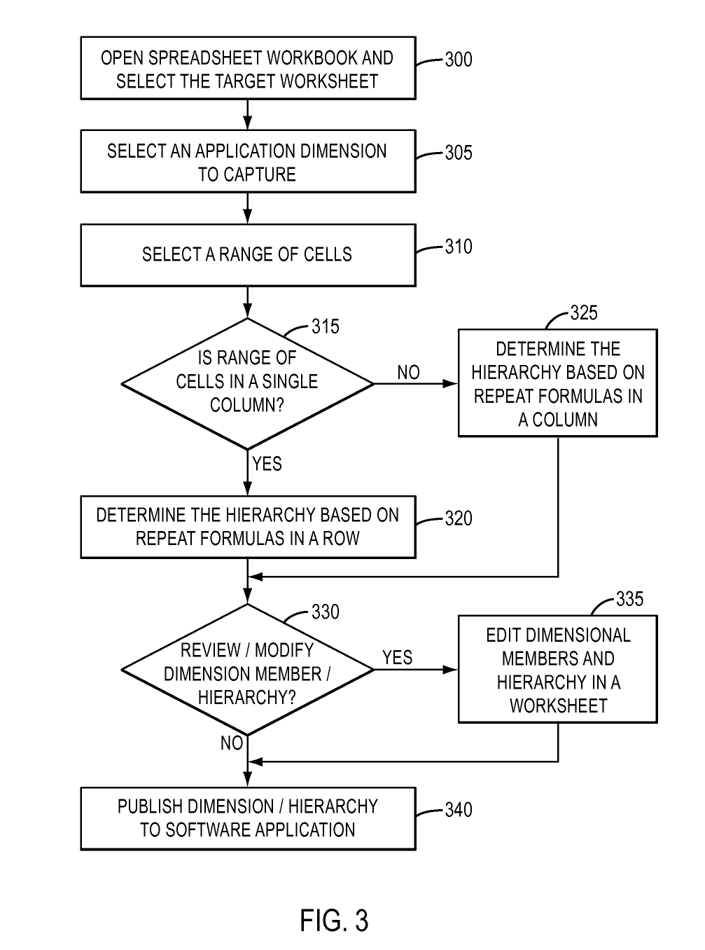

Turning now to FIG. 3, a flowchart illustrating an example of steps performable to capture dimensional members and hierarchy is provided. The user can begin by opening a spreadsheet workbook and selecting a target worksheet (Step 300). The user then selects an application dimension to capture (Step 305). A range of cells in the worksheet is then selected (Step 310). The CPM module 120 then determines if the range of cells selected is in a single column (Step 315). If the range of cells selected is in a single column, the CPM module 120 can be configured to determine a hierarchy based on repeat formulas in a row (Step 320). If the range of cells selected is not in a single column, the CPM module 120 can determine a hierarchy based on repeat formulas in a column (Step 325). As illustrated in this example, the CPM module 120 then reviews and/or determines whether to modify one or more dimension members and/or hierarchies (Step 330). In one embodiment, the CPM module 120 determines whether to modify a dimension member if, for example, the dimension member uses similar but not exactly the same words as what is used by the CPM module 120. If the CPM module 120 determines that modification is needed, the CPM module 120 edits dimensional members and hierarchy in a worksheet (Step 335). In one example, if the CPM module 120 determines that there are no validation errors, then the CPM module 120 constructs the hierarchy based upon the range of cells selected. If there are validation errors, then the CPM module 120 will display an error indicating what needs to be corrected before the CPM module 120 can continue. In one embodiment, once the hierarchy is constructed, the user can review in advance of a publishing operation. The CPM module 120 then publishes the dimension/hierarchy to an application (e.g., CPM software application 280 or other software program) (Step 340).

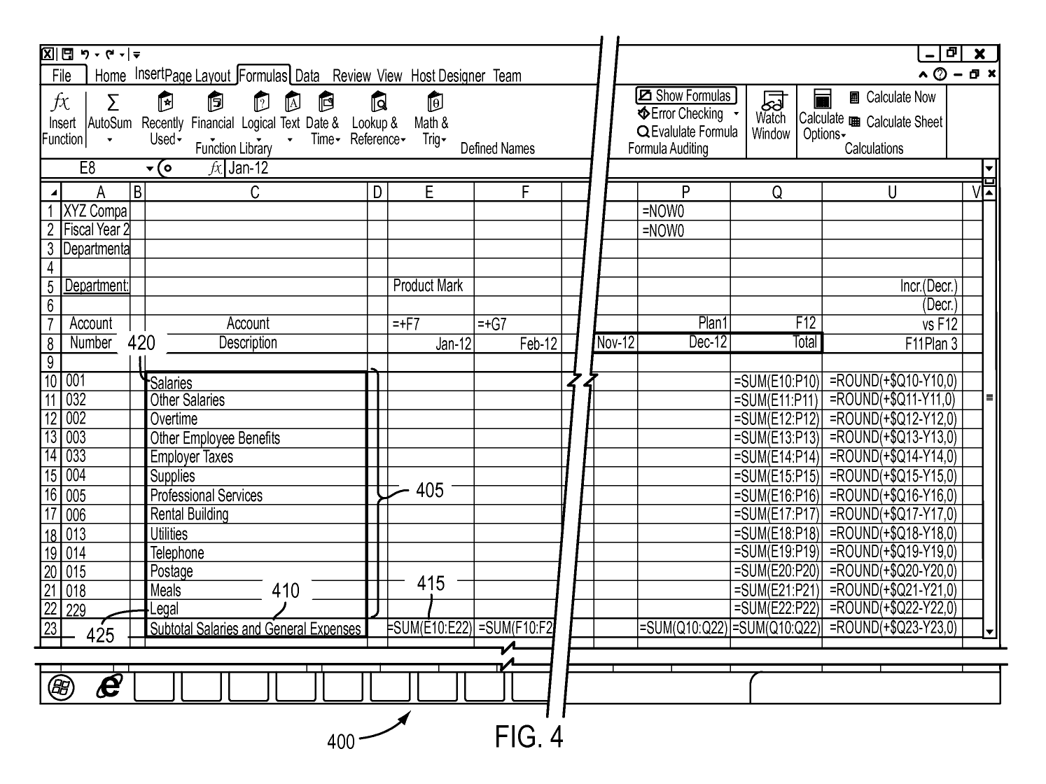

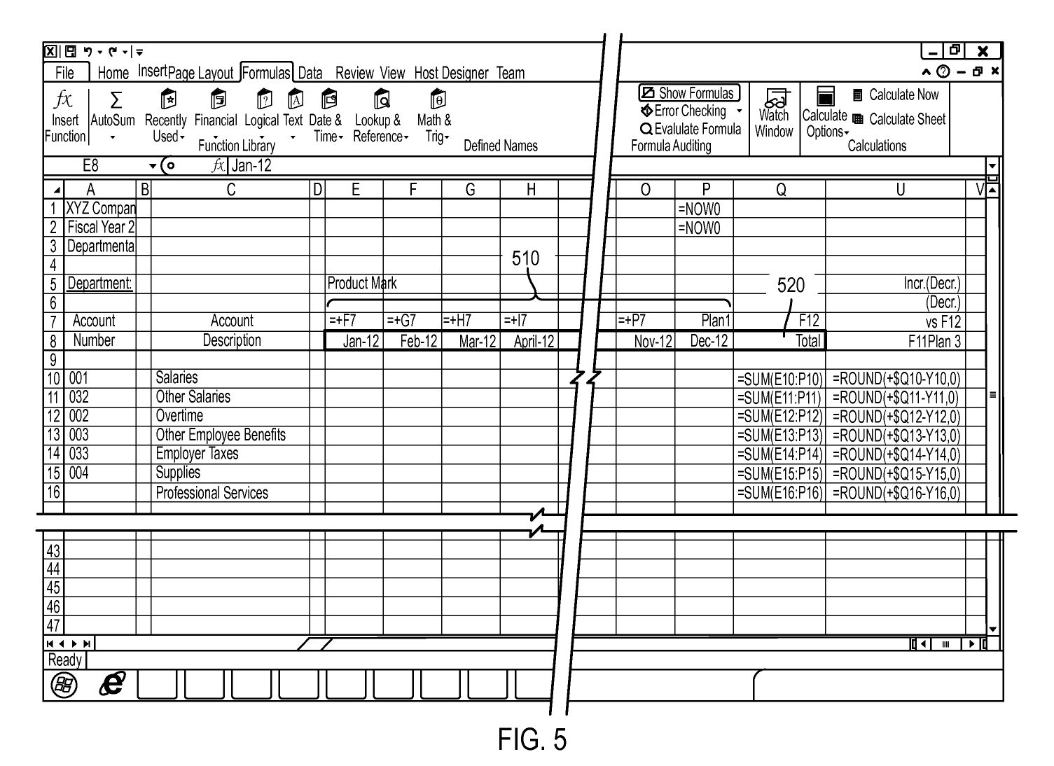

FIG. 4 illustrates an example of an Excel® template 400 showing the capturing of dimensional members and hierarchy. The user opens template 400 in Excel®. The user then highlights a range of cells 405 that represents information such as Accounts. This is repeated as many times as necessary or desired to capture the dimensional information to build in the CPM application(s) 280. Based on the range of accounts that were selected and tagged (as described below), the CPM module 120 scans (e.g., automatically) the template for formulas which will give definition to how the hierarchy should be created. In FIG. 4, for example, the “Subtotal Salaries and General Expenses” hierarchy 410 for Accounts is built based upon the sum formula (e.g., formula 415) included in Row 23. Therefore, all Accounts from Salaries 420 down through Legal 425 would be incorporated into Subtotal Salaries and General Expenses 410. As is also shown in FIG. 5, the same procedure occurs for time periods 510 (here, January 12 through December 12) and is incorporated into Total 520. Once this tagging is complete, the user can then publish this information to a CPM software application 280 where these structures are created automatically for the user.

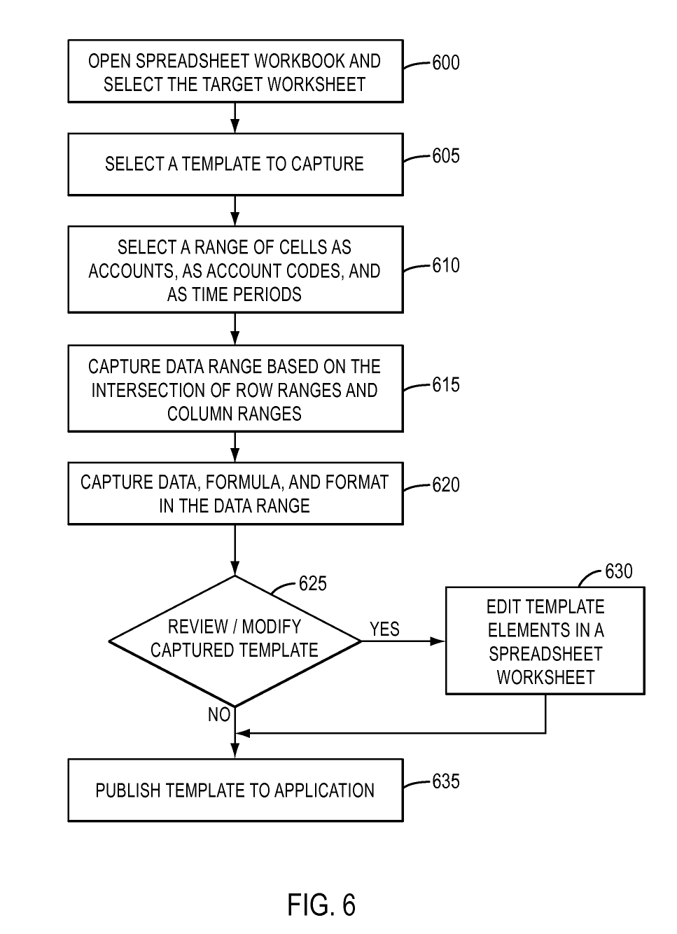

FIG. 6 is a flowchart illustrating an example of steps performed to capture a spreadsheet template. As illustrated, the user opens a spreadsheet workbook and selects a target worksheet (Step 600). The user selects a template to capture (Step 605). The user then selects a range of cells (e.g., as accounts, as account codes, and as time periods) (Step 610). The CPM module 120 then captures a data range based on the intersection of row ranges and column ranges (Step 615). In some configurations, the CPM module 120 is configurable such that it also captures the data, formula, and format in the data range (Step 620). Steps 615 and 620 can happen simultaneously or sequentially, and may or may not be combined into a single step. The CPM module 120 reviews the captured template and determines whether any modifications need to occur (Step 625). If so, the CPM module 120 edits template elements in a spreadsheet worksheet (Step 630). The CPM module 120 then publishes the template to a software application (Step 635).

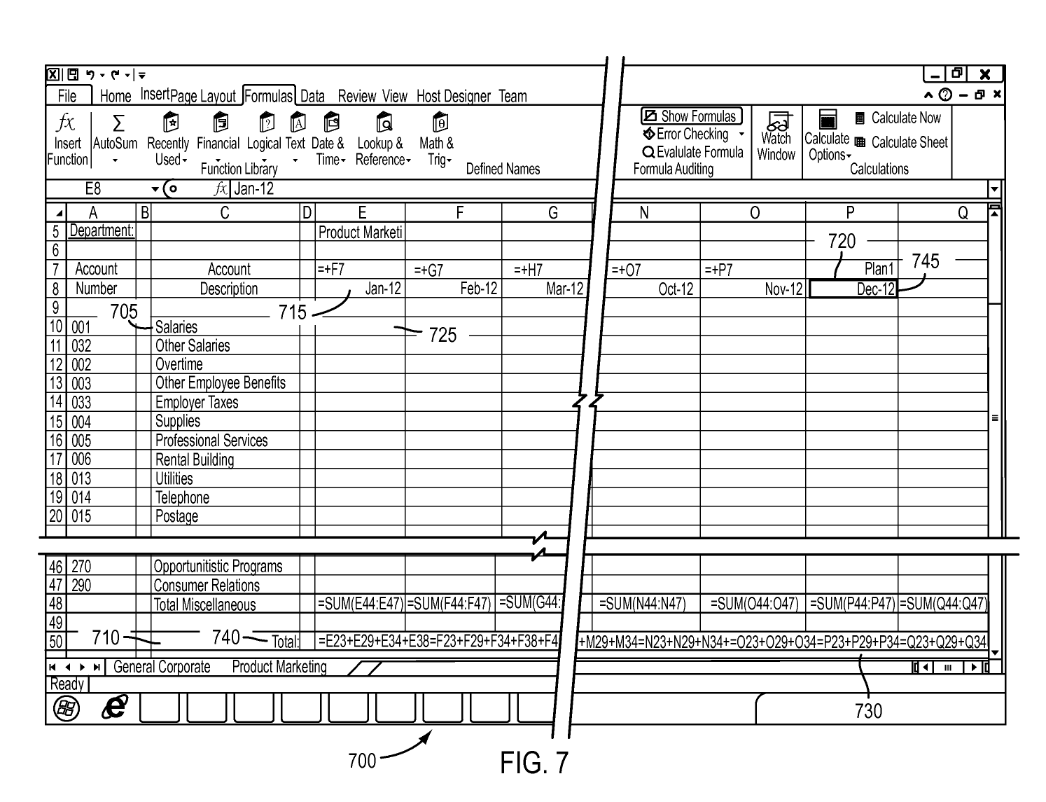

Turning now to FIG. 7, an example of an implementation of an Excel® planning template 700 is provided to illustrate the capturing of the template 700. The user opens template 700 in Excel®. The user can then tag each area of the template 700 by highlighting each range and defining the segment associated with the template design 700 (e.g., Accounts, Companies, Time Periods, etc.). For example, in FIG. 7, the user can capture the rows from C10 705 to C50 710 (C10:C50). The user can then capture Time Periods from E8 715 to P8 720 (E8:P8). The CPM module 120 can then capture the data from E10 725 to P50 730 (E10:P50). As will be appreciated by those skilled in the art, the user or the CPM module 120 can then perform other tasks, such as the auto-mapping of Account elements to ensure proper matching with a destination software application or additional template definitions. Once complete, the CPM module 120 publishes this information to the software application (e.g., CPM software application 280).

The CPM module 120 is configurable to define the tagging based upon the formulas which are included directly in the Excel® template itself For example, in FIG. 7, if the user selects the Total cell 740 in C50 and the Total Period cell 745 in P8, the CPM module 120 can scan the formulas in the template 700 and construct the account structure, time period structure, and the associated formula relationships which will drive the data on the template 700. Similar to above, additional items can be configured before publishing. Once this initial tagging is complete, the CPM module 120 can publish the template 700 to the software application for creation.

Thus, the CPM module 120 can tag existing templates, perform auto-mapping of segment members, and maintain bi-directional communication of information. Tagging includes, for example, the process by which a customer defines attributes of their spreadsheet template. Tags facilitate determining how items will map from a source spreadsheet template to a CPM software application definition. This process can be configurable to allow a user to identify attributes of the source template that the user wants to use to construct new CPM application objects. These could include items such as the definitions of accounts for which users will plan or budget, time periods, or formatting of the template.

Tagging can also include the ability to take the relationships that are set-out in the tag to construct either hierarchies or template definitions (structure and/or formulas). Thus, for example, the CPM module 120 is configurable such that it will scan the template looking for relationships based upon the area of the template which has been tagged. These relationships can be found in spreadsheet formulas. The CPM module 120 can then use these formulas either to build relationships (e.g., do all members sum to a parent) or to execute formula calculations (e.g., do the formulas contain an if/then statement that evaluates data based upon prior inputs). The former can be used to build structure while the latter can be used to ensure a proper template design and calculation.

In some configurations, auto-mapping is used to leverage an existing CPM application structure and keyword matching to facilitate creation of templates without manual intervention based upon an existing spreadsheet template definition. For example, if an Excel® template has accounts called “Income” and “Margin” but, in the CPM software application 280, the accounts are called “Net Income” and “Gross Margin”, then in an auto-map can be configured to scan available options and provide a match (e.g., the closest match, a word or words having a number above a predetermined number of letters (or characters) that are the same, etc.). The CPM module 120, in some instances, provides the user with the ability to override the auto-mapping. The auto-mapping can also reduce the time required to set up new template definitions for CPM software application template designs.

To enable tagging and auto-mapping features, a bi-directional communication protocol is used so that information that already exists in the CPM software application 280 can be communicated to the CPM module 120. Similarly, once definitions (e.g., tags or mappings) are complete in the CPM module 120, the definitions need to be sent to the CPM software application 280 for construction. Application programming interfaces (APIs) leveraged in a bi-directional manner allow users to stay in a single interface and perform the tasks necessary to complete their work. This typically saves users time and makes for a more positive user experience. The CPM module 120 reduces the time required for a user to be implemented to or use the CPM application 280.

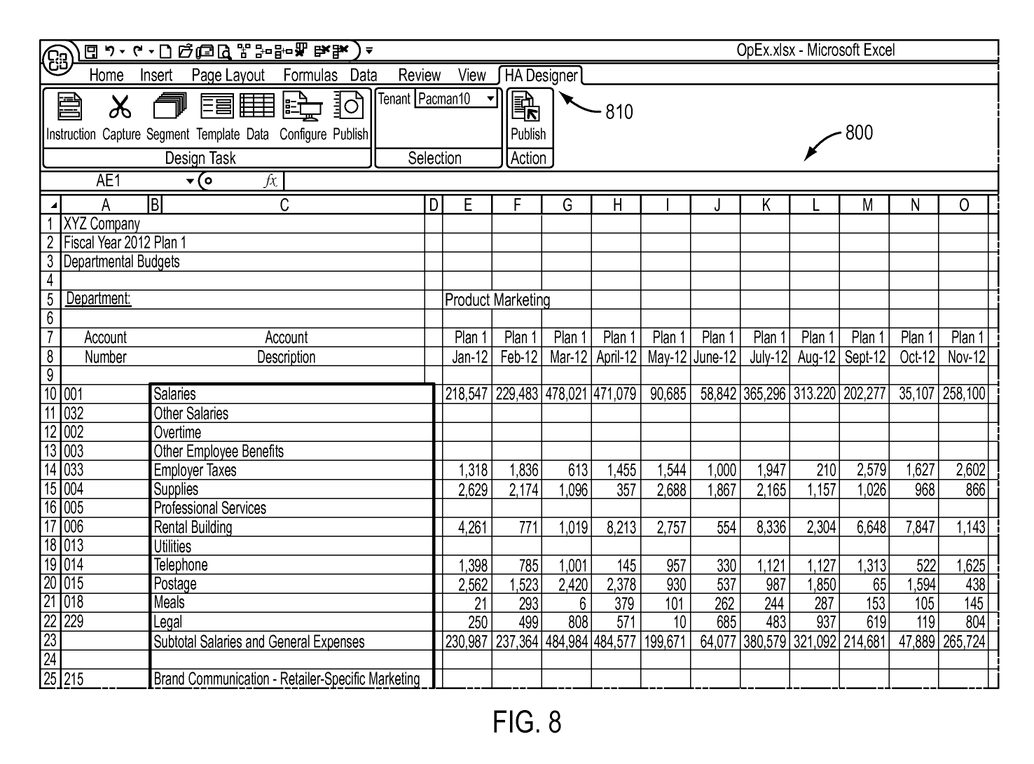

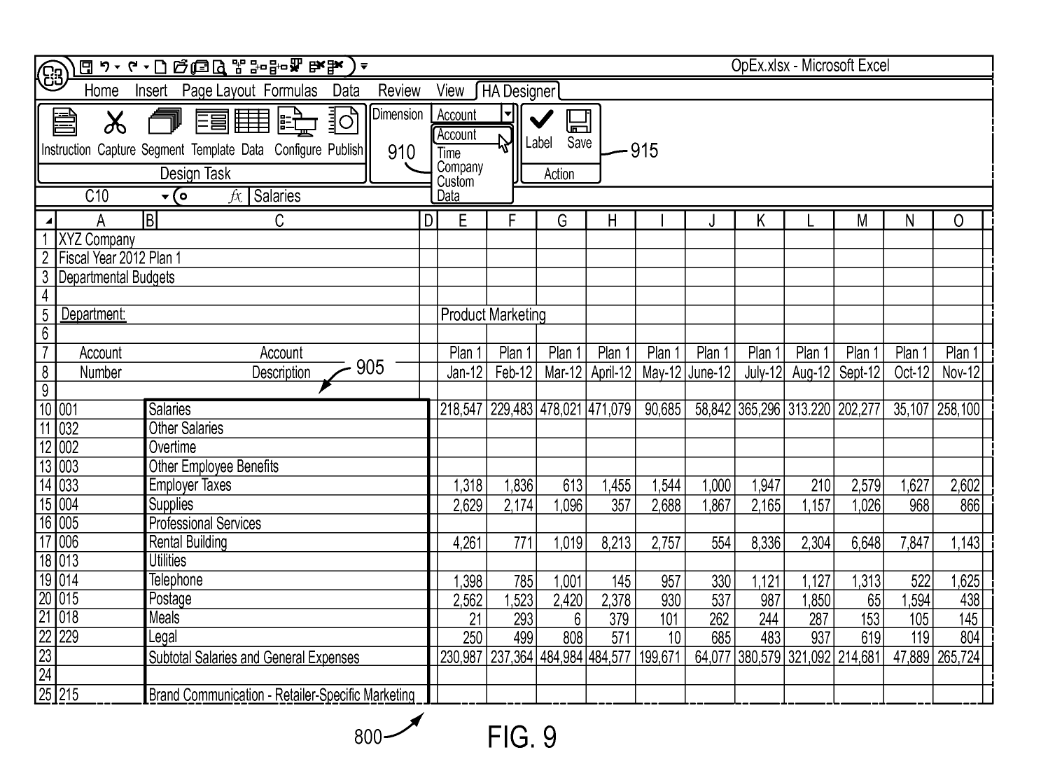

FIG. 8 shows an Excel® template 800 for capturing by the CPM module 120. The Excel® template 800 is the departmental budget for the fiscal year 2012 Plan 1 for XYZ Company. The CPM module 120 displays one or more icons, menus, and/or ribbons 810 for selection by the user to cause the CPM module 120 to perform one or more specific actions with respect to template 800. FIG. 9 shows a capturing process of the template 800 by the CPM module 120. An area 905 of the Excel® template 800 is highlighted to be captured. As shown, area 905 is a list of Accounts. The user selects a dimension 910 as “Account” to indicate to the CPM module 120 which dimension is being captured. The user then can select an action 915 to be taken on selection, such as to label or save what is to be captured.

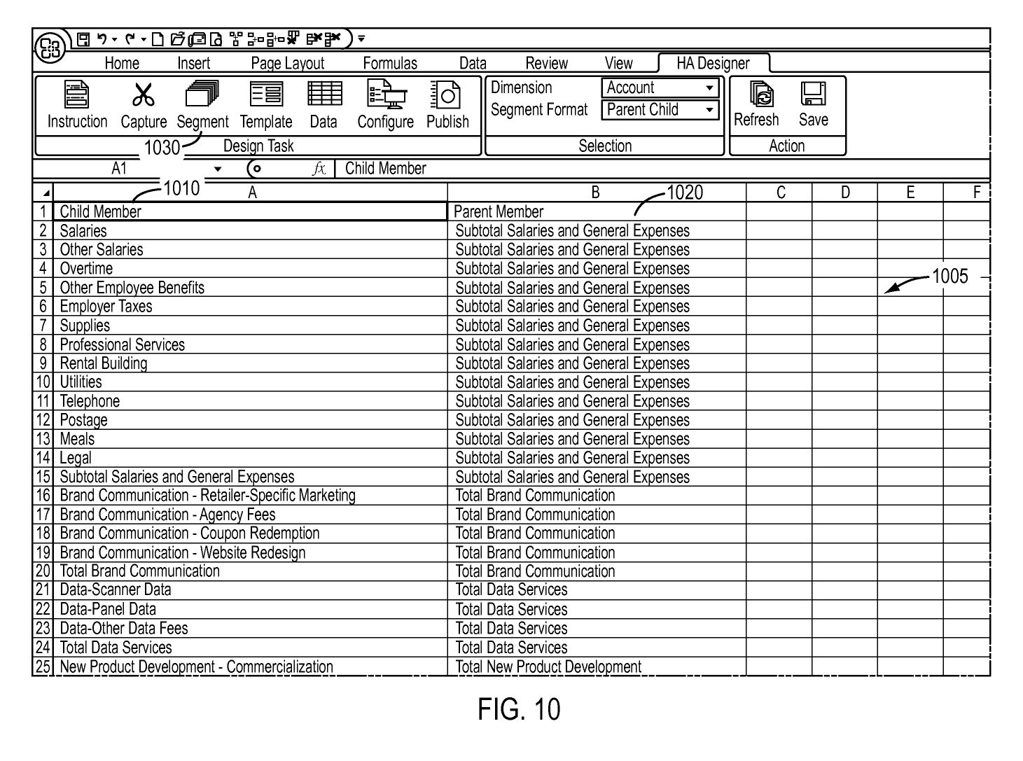

FIG. 10 shows the relationship of dimensional members 1005 with respect to template 800. The dimensional members 1005 include child members 1010 and parent members 1020. The CPM module 120 creates a hierarchy based on the layout of the template 800. For example, child members Salaries, Other Salaries, Overtime, etc. are incorporated into parent member “Subtotal Salaries and General Expense”. This hierarchy was creatable because of the Excel® template formula for summing those cells into a total line called Subtotal Salaries and General Expense (as shown in FIGS. 8-9). A Segment icon 1030 can be provided which is selected by the user to display the dimensional members 1005 to add to the CPM application 280.

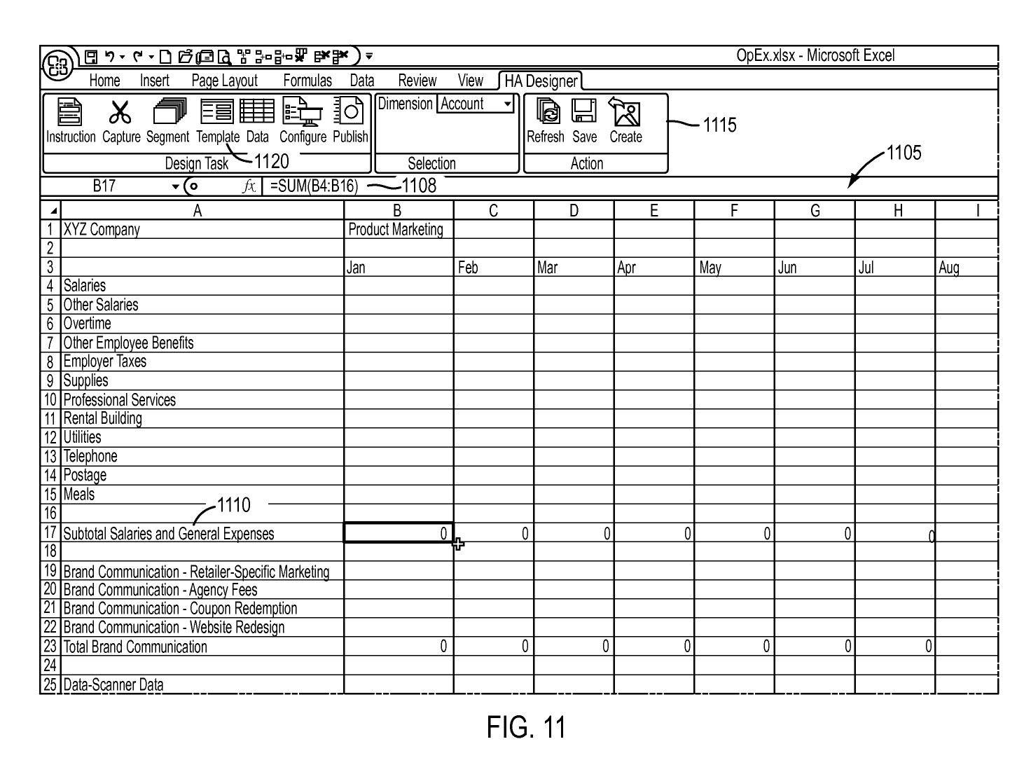

FIG. 11 shows a template design 1105 created by the CPM module 120 for the CPM software application 280. The formulas for the subtotal rows, such as the formula 1108 for Subtotal Salaries and General Expense 1110, are identical to the source Excel® template 800. The other dimensions are represented as how they were captured (e.g., Time, Company, Custom, Account). In ribbon 1115, the user has selected a Template button 1120 to perform the above function.

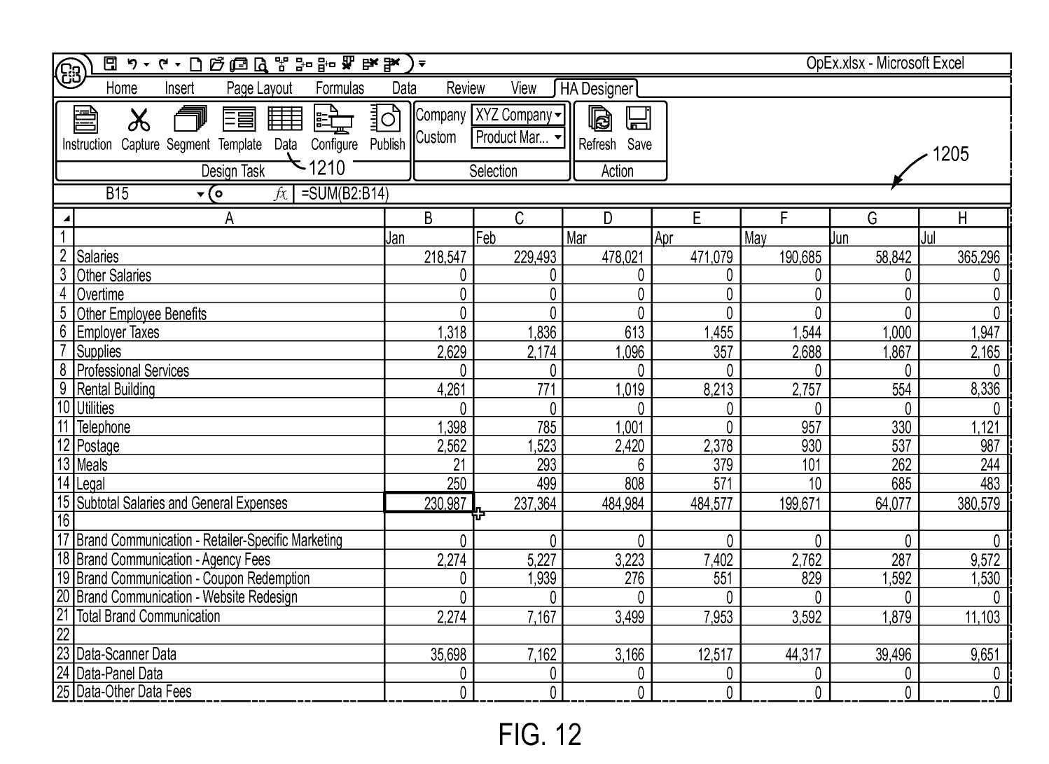

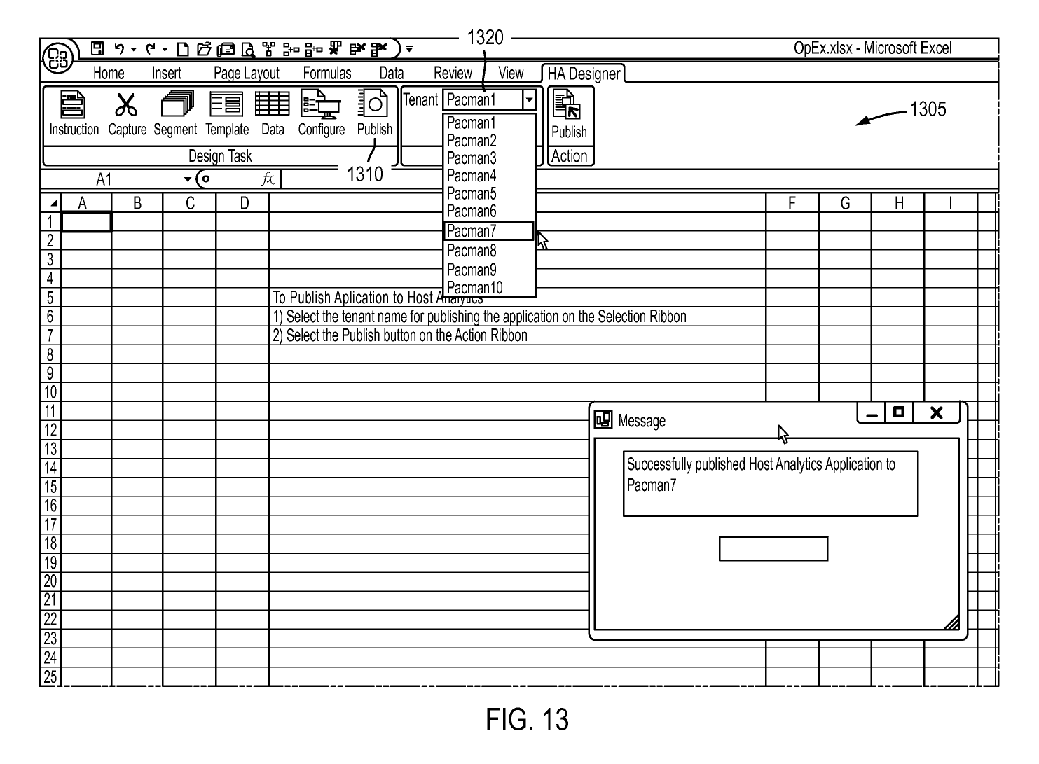

FIG. 12 shows an example of data 1205 that will be loaded into the CPM software application 280. As illustrated the user can select a Data button 1210 to load the data by the CPM module 120 to the CPM software application 280. FIG. 13 shows a user selecting to publish the captured information to the CPM software application 280. Ribbon 1305 of the spreadsheet 800 includes a publish button 1310. When the publish button 1310 is selected, the user can select a destination application (e.g., Pacman1) 1320 and, once the publish process is complete, a status update is presented.

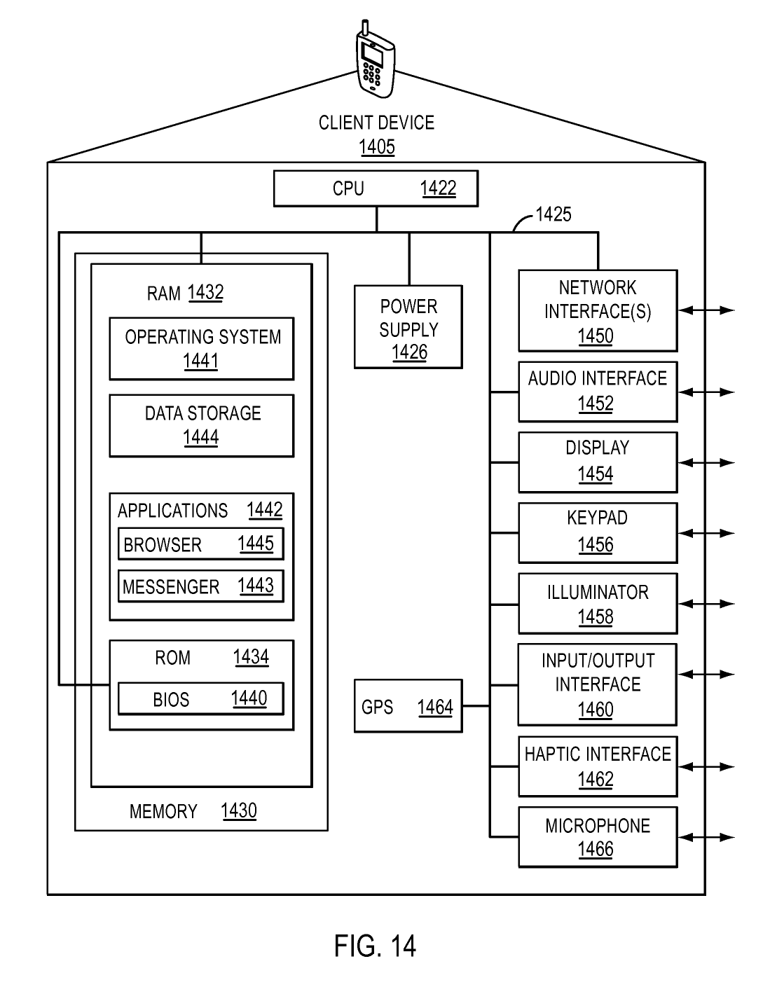

FIG. 14 shows a schematic diagram illustrating a client device 1405 which may include any suitable computing device capable of sending or receiving signals, such as via a wired or wireless network. A client device 1405 may, for example, include a desktop computer or a portable device, such as a cellular telephone, a smartphone, a display pager, a radio frequency (RF) device, an infrared (IR) device, a Personal Digital Assistant (PDA), a handheld computer, a tablet computer, a laptop computer, a digital camera, a set top box, a wearable computer, an integrated device combining various features, such as features of the foregoing devices, or the like.

The client device 1405 may vary in terms of capabilities or features. Claimed subject matter is intended to cover a wide range of potential variations. For example, a cell phone may include a numeric keypad or a display of limited functionality, such as a monochrome liquid crystal display (LCD) for displaying text, pictures, etc. In contrast, however, as another example, a web-enabled client device may include one or more physical or virtual keyboards, mass storage, one or more accelerometers, one or more gyroscopes, global positioning system (GPS) or other location-identifying type capability, of a display with a high degree of functionality, such as a touch-sensitive color 2D or 3D display, for example.

A client device 1405 may include or may execute a variety of operating systems, including a personal computer operating system, such as a Windows, iOS or Linux, or a mobile operating system, such as iOS, Android, or Windows Mobile, or the like. A client device may include or may execute a variety of possible applications, such as a client software application enabling communication with other devices, such as communicating one or more messages, such as via email, short message service (SMS), or multimedia message service (MMS), including via a network, such as a social network, including, for example, Facebook®, LinkedIn®, Twitter®, Flickr®, or Google+®, to provide only a few possible examples. Additionally, a client device may also include or execute an application to communicate content, such as, for example, textual content, multimedia content, or the like. Moreover, a client device may also include or execute an application to perform a variety of possible tasks, such as browsing, searching, playing various forms of content, including locally stored or streamed video, or games (such as fantasy sports leagues). The foregoing is provided to illustrate that claimed subject matter is intended to include a wide range of possible features or capabilities.

As shown in the example of FIG. 14, client device 1405 may include one or more processing units (also referred to herein as CPUs) 1422, which interface with at least one computer bus 1425. A memory 1430 can be persistent storage and interfaces with the computer bus 1425. The memory 1430 includes RAM 1432 and ROM 1434. ROM 1434 includes a BIOS 1440. Memory 1430 interfaces with computer bus 1425 so as to provide information stored in memory 1430 to CPU 1422 during execution of software programs such as an operating system 1441, application programs 1442, device drivers, and software modules 1443, 1445 that comprise program code, and/or computer-executable process steps, incorporating functionality described herein, e.g., one or more of process flows described herein. CPU 1422 first loads computer-executable process steps from storage, e.g., memory 1432, data storage medium/media 1444, removable media drive, and/or other storage device. CPU 1422 can then execute the stored process steps in order to execute the loaded computer-executable process steps. Stored data, e.g., data stored by a storage device, can be accessed by CPU 1422 during the execution of computer-executable process steps.

Persistent storage medium/media 1444 is a computer readable storage medium(s) that can be used to store software and data, e.g., an operating system and one or more application programs. Persistent storage medium/media 1444 can also be used to store device drivers, such as one or more of a digital camera driver, monitor driver, printer driver, scanner driver, or other device drivers, web pages, content files, playlists and other files. Persistent storage medium/media 1444 can further include program modules and data files used to implement one or more aspects of the present disclosure.

As will be appreciated by those skilled in the art, a computer readable medium is configurable such that it stores computer data, which data can include computer program code that is executable by a computer, in machine readable form. By way of example, and not limitation, a computer readable medium may comprise computer readable storage media, for tangible or fixed storage of data, or communication media for transient interpretation of code-containing signals. Computer readable storage media thus can refer to physical or tangible storage (as opposed to signals) and includes without limitation volatile and non-volatile, removable and non-removable media implemented in any method or technology for the tangible storage of information such as computer-readable instructions, data structures, program modules or other data. Additionally, computer readable storage media can include, but is not limited to, RAM, ROM, EPROM, EEPROM, flash memory or other solid state memory technology, CD-ROM, DVD, or other optical storage, magnetic cassettes, magnetic tape, magnetic disk storage or other magnetic storage devices, or any other physical or material medium which can be used to tangibly store the desired information or data or instructions and which can be accessed by a computer or processor.

Client device 1405 can also include one or more of a power supply 1426, network interface 1450, audio interface 1452, a display 1454 (e.g., a monitor or screen), keypad 1456, illuminator 1458, I/O interface 1460, a haptic interface 1462, a GPS 1464, and/or a microphone 1466.

A module can be a software, hardware, or firmware (or combinations thereof) system, process or functionality, or component thereof, that performs or facilitates the processes, features, and/or functions described herein (with or without human interaction or augmentation). A module can also include sub-modules. Software components of a module may be stored on a computer readable medium. Modules may be integral to one or more servers, or be loaded and executed by one or more servers. One or more modules may be grouped into an engine or an application.

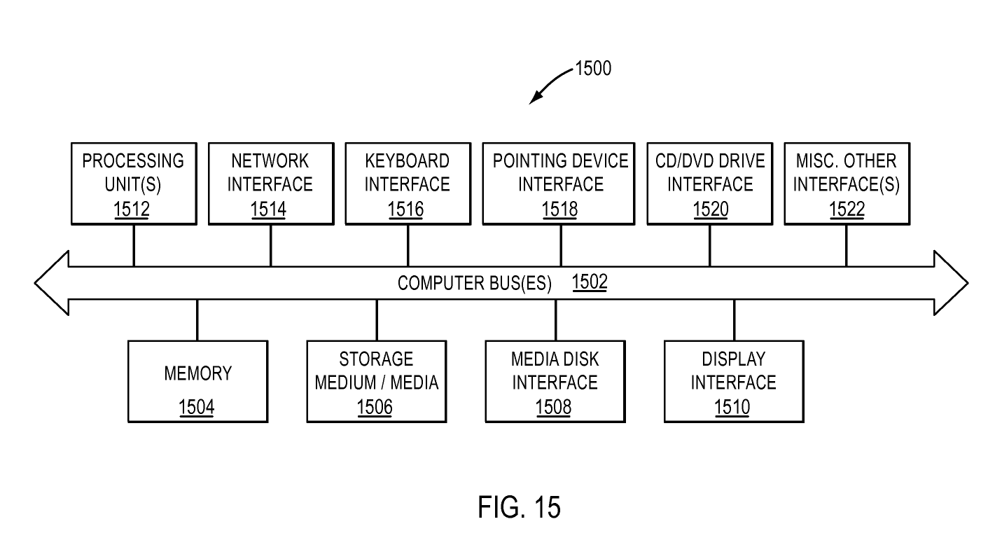

FIG. 15 is a block diagram illustrating an internal architecture of an example of a computer, such as server computer 115 and/or client device 105 in accordance with one or more aspects of the present disclosure. A computer can be any device with a processor capable of executing logic or coded instructions, and could, for example, be a server, personal computer, set top box, tablet, smart phone, pad computer or media device, to name a few such devices. As shown in FIG. 15, internal architecture 1500 can be configured to include one or more processing units (also referred to herein as CPUs) 1512, which interface with at least one computer bus 1502. Also interfacing with computer bus 1502 are persistent storage medium/media 1506, network interface 1514, memory 1504, e.g., random access memory (RAM), run-time transient memory, read only memory (ROM), etc., media disk drive interface 1508 as an interface for a drive that can read and/or write to media including removable media such as floppy, CD-ROM, DVD, etc. media, display interface 1510 as interface for a monitor or other display device, keyboard interface 1516 as interface for a keyboard, pointing device interface 1518 as an interface for a mouse or other pointing device, and miscellaneous other interfaces not shown individually, such as parallel and serial port interfaces, a universal serial bus (USB) interface, and the like.

Memory 1504 is configurable to interface with computer bus 1502 to provide information stored in memory 1504 to CPU 1512 during execution of software programs such as an operating system, application programs, device drivers, and software modules that comprise program code, and/or computer-executable process steps, incorporating functionality described herein, e.g., one or more of process flows described herein. CPU 1512 first loads computer-executable process steps from storage, e.g., memory 1504, storage medium/media 1506, removable media drive, and/or other storage device. CPU 1512 can then execute the stored process steps in order to execute the loaded computer-executable process steps. Stored data, e.g., data stored by a storage device, can be accessed by CPU 1512 during the execution of computer-executable process steps.

As described above, persistent storage medium/media 1506 is a computer readable storage medium(s) that can be used to store software and data, e.g., an operating system and one or more application programs. Persistent storage medium/media 1506 can also be used to store device drivers, such as one or more of a digital camera driver, monitor driver, printer driver, scanner driver, or other device drivers, web pages, content files, playlists and other files. Persistent storage medium/media 1506 can further include program modules and data files used to implement one or more aspects of the present disclosure.

Those skilled in the art will recognize that the methods and systems of the present disclosure may be implemented in many manners and as such are not to be limited by the foregoing exemplary embodiments and examples. In other words, functional elements being performed by single or multiple components, in various combinations of hardware and software or firmware, and individual functions, may be distributed among software applications at either the user computing device or server or both. In this regard, any number of the features of the different embodiments described herein may be combined into single or multiple embodiments, and alternate embodiments having fewer than, or more than, all of the features described herein are possible. Functionality may also be, in whole or in part, distributed among multiple components, in manners now known or to become known. Thus, myriad software/hardware/firmware combinations are possible in achieving the functions, features, interfaces and preferences described herein. Moreover, the scope of the present disclosure covers conventionally known manners for carrying out the described features and functions and interfaces, as well as those variations and modifications that may be made to the hardware or software or firmware components described herein as would be understood by those skilled in the art now and hereafter.

While preferred embodiments of the present invention have been shown and described herein, it will be obvious to those skilled in the art that such embodiments are provided by way of example only. Numerous variations, changes, and substitutions will now occur to those skilled in the art without departing from the invention. It should be understood that various alternatives to the embodiments of the invention described herein may be employed in practicing the invention. It is intended that the following claims define the scope of the invention and that methods and structures within the scope of these claims and their equivalents be covered thereby.

What is claimed is:

1. A method comprising:
determining, by a computing device, a spreadsheet for inclusion in a Corporate Performance Management (CPM) software application;
capturing, by the computing device, dimensional members associated with the spreadsheet; and
determining, by the computing device, hierarchies associated with the spreadsheet based on the captured dimensional members and formulas in the spreadsheet.

2. The method of claim 1 wherein the determining of the spreadsheet further comprises receiving, by the computing device, the spreadsheet from a user.

3. The method of claim 1 wherein the capturing of the dimensional members further comprises receiving, by the computing device, a selection of a range of cells in the spreadsheet.

4. The method of claim 3 further comprising determining if the range of cells is in a single column in the spreadsheet.

5. The method of claim 4 wherein the determining of the hierarchies further comprises determining a hierarchy based on repeat spreadsheet formulas in a column if the range of cells is in multiple columns.

6. The method of claim 4 wherein the determining of the hierarchies further comprises determining a hierarchy based on repeat spreadsheet formulas in a row if the range of cells is in the single column.

7. The method of claim 1 further comprising enabling, by the computing device, editing of the dimensional members and hierarchies.

8. The method of claim 1 further comprising obtaining, by the computing device, data from the spreadsheet.

9. A method comprising:
capturing, by a computing device, a spreadsheet template associated with a spreadsheet; and
publishing, by the computing device, the spreadsheet template, dimensional members, hierarchies, and data into a Corporate Performance Management (CPM) software application.

10. The method of claim 9 wherein the capturing of the spreadsheet template further comprises receiving, by the computing device, a selection of the spreadsheet template.

11. The method of claim 9 wherein the capturing of the spreadsheet template further comprises receiving, by the computing device, a selection of a range of cells in the spreadsheet.

12. The method of claim 11 further comprising capturing, by the computing device, a data range based on an intersection of row ranges and column ranges.

13. The method of claim 12 further comprising capturing, by the computing device, data, formula, and format in the data range.

14. The method of claim 9 further comprising determining, by the computing device, the spreadsheet for inclusion in the CPM software application.

15. The method of claim 9 further comprising capturing, by the computing device, dimensional members associated with the spreadsheet.

16. The method of claim 15 further comprising determining, by the computing device, hierarchies associated with the spreadsheet based on the captured dimensional members and formulas in the spreadsheet.

17. The method of claim 9 further comprising obtaining, by the computing device, data from the spreadsheet.

18. A computing device comprising:
a processor;
a storage medium for tangibly storing thereon program logic for execution by the processor, the program logic comprising:
spreadsheet determining logic executed by the processor for determining a spreadsheet for inclusion in a Corporate Performance Management (CPM) software application;
dimensional member capturing logic executed by the processor for capturing dimensional members associated with the spreadsheet; and
hierarchy determining logic executed by the processor for determining hierarchies associated with the spreadsheet based on the captured dimensional members and formulas in the spreadsheet.

19. The computing device of claim 18 wherein the dimensional member capturing logic further comprises receiving logic for receiving a selection of a range of cells in the spreadsheet.

20. The computing device of claim 19 further comprising determining logic for determining whether the range of cells is in a single column in the spreadsheet.

21. The computing device of claim 20 wherein the hierarchy determining logic further comprises determining logic for determining a hierarchy based on repeat spreadsheet formulas in a column if the range of cells is in multiple columns.

22. The computing device of claim 20 wherein the hierarchy determining logic further comprises determining logic for determining a hierarchy based on repeat spreadsheet formulas in a row if the range of cells is in the single column.

23. The computing device of claim 18 further comprising data obtaining logic executed by the processor for obtaining data from the spreadsheet.

24. A computing device comprising:
a processor;
a storage medium for tangibly storing thereon program logic for execution by the processor, the program logic comprising:
template capturing logic executed by the processor for capturing a spreadsheet template associated with a spreadsheet; and
publishing logic executed by the processor for publishing the spreadsheet template, dimensional members, hierarchies, and data into a Corporate Performance Management (CPM) software application.

25. The computing device of claim 24 wherein the template capturing logic further comprises receiving logic for receiving a selection of a range of cells in the spreadsheet.

26. The computing device of claim 25 further comprising data range capturing logic for capturing a data range based on an intersection of row ranges and column ranges.

27. The computing device of claim 26 further comprising data capturing logic for capturing data, formula, and format in the data range.

28. The computing device of claim 24 further comprising spreadsheet determining logic executed by the processor for determining the spreadsheet for inclusion in the CPM software application.

29. The computing device of claim 24 further comprising dimensional member capturing logic executed by the processor for capturing dimensional members associated with the spreadsheet.

30. The computing device of claim 29 further comprising hierarchy determining logic executed by the processor for determining hierarchies associated with the spreadsheet based on the captured dimensional members and formulas in the spreadsheet.

31. A non-transitory computer readable storage medium tangibly storing computer program instructions capable of being executed by a computer processor, the computer program instructions defining the steps of:
determining, by the computer processor, a spreadsheet for inclusion in a Corporate Performance Management (CPM) software application;
capturing, by the computer processor, dimensional members associated with the spreadsheet; and
determining, by the computer processor, hierarchies associated with the spreadsheet based on the captured dimensional members and formulas in the spreadsheet.

32. The non-transitory computer readable storage medium of claim 31 wherein the step of capturing of the dimensional members further comprises receiving, by the computer processor, a selection of a range of cells in the spreadsheet.

33. The non-transitory computer readable storage medium of claim 32 further comprising determining if the range of cells is in a single column in the spreadsheet.

34. The non-transitory computer readable storage medium of claim 33 wherein the determining of the hierarchies further comprises determining a hierarchy based on repeat spreadsheet formulas in a column if the range of cells is in multiple columns.

35. The non-transitory computer readable storage medium of claim 33 wherein the determining of the hierarchies further comprises determining a hierarchy based on repeat spreadsheet formulas in a row if the range of cells is in the single column.

36. The non-transitory computer readable storage medium of claim 32 further comprising obtaining, by the computer processor, data from the spreadsheet.

37. A non-transitory computer readable storage medium tangibly storing computer program instructions capable of being executed by a computer processor, the computer program instructions defining the steps of:
capturing, by the computer processor, a spreadsheet template associated with a spreadsheet; and
publishing, by the computer processor, the spreadsheet template, dimensional members, hierarchies, and data into a Corporate Performance Management (CPM) software application.

38. The non-transitory computer readable storage medium of claim 37 wherein the capturing of the spreadsheet template further comprises receiving, by the computer processor, a selection of a range of cells in the spreadsheet.

39. The non-transitory computer readable storage medium of claim 38 further comprising capturing, by the computer processor, a data range based on an intersection of row ranges and column ranges.

40. The non-transitory computer readable storage medium of claim 39 further comprising capturing, by the computer processor, data, formula, and format in the data range.

41. The non-transitory computer readable storage medium of claim 37 further comprising capturing, by the computer processor, dimensional members associated with the spreadsheet.

42. The non-transitory computer readable storage medium of claim 41 further comprising determining, by the computer processor, hierarchies associated with the spreadsheet based on the captured dimensional members and formulas in the spreadsheet.
